(19) United States
(12) Patent Application Publication
(10) Pub. No.: US 2006/0195329 A1
(43) Pub. Date: Aug. 31, 2006

(54) Dynamic credit amount and salary information display during flexible benefit enrollment

(76) Inventors: Richard F. Choi, San Francisco, CA (US); Jun Zhang, Beijing (CN); Shouxin Wang, Beijing (CN); Xin Wang, Beijing (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/067,625

(22) Filed: Feb. 28, 2005

(51) Int. Cl. G06Q 99/00

(52) U.S. Cl. 705/1

(57) ABSTRACT

A method for updating a benefit program with a plurality of plans receives an input from an individual indicating a change to the benefit program, and updates the benefit program and the salary information of the individual consistent with the input. The individual is presented with a summary of the updated benefit program and the updated salary information, and can indicate additional changes to the benefit plan immediately after the summary presented to the individual.

### TECHNICAL FIELD

The present invention relates to methods and systems for enrolling an individual in a benefit program and, more particularly, to methods and systems that present individual with salary information during the enrollment process.

### DESCRIPTION OF THE RELATED ART

The benefit program enrollment system is often a software application run on a computer, and is accessed through websites either locally, i.e., from the computer where the software application is run, or, more frequently, remotely through intranet or internet. After logging on, the system presents the employee with the available benefit plans, such as health plans, dental plans, retirement fund plans, vacation plans, etc. The employee selects the desired plans and options, which the system stores before the employee logs out.

The cost for the selected plans either may be contributed by the employee, contributed by the employer, or shared by the employee and the employer. Oftentimes the employee would like to know how much is contributed by the employee and how the cost would impact his salary. Some benefit program enrollment systems allow the employee to review salary information, such as gross pay and deductions for the benefit plans, at the end of the enrollment process. After such review, the employee may make further adjustments to the benefit plans.

### SUMMARY

A method, consistent with the invention and performed by a processing system, for updating a benefit program for an individual, comprises receiving from the individual a input indicating a desired change to the benefit program; updating the benefit program at a data processor to reflect the desired change and to adjust salary information for the individual consistent with the desired change immediately after receiving the input; presenting to the individual a summary of the updated benefit program and the adjusted salary information immediately after updating the benefit program and adjusting the salary information; and allowing the individual to indicate additional changes to the benefit plan immediately after having the summary presented to the individual.

A computer-readable medium, consistent with the invention, contains a program for causing a processor to perform a method for updating a benefit program for an individual. The method includes receiving from the individual an input indicating a desired change to the benefit program, updating the benefit program at a data processor to reflect the desired change and to adjust salary information for the individual consistent with the desired change immediately after receiving the input, presenting to the individual a summary of the updated benefit program and the adjusted salary information immediately after updating the benefit program and adjusting the salary information, and allowing the individual to indicate additional changes to the benefit plan immediately after having the summary presented to the individual.

A computer system, consistent with the invention, includes a processor and means for accessing a computer-readable medium containing a program for causing the processor to perform a method for updating a benefit program for an individual. The method includes receiving from the individual an input indicating a desired change to the benefit program, updating the benefit program at a data processor to reflect the desired change and to adjust salary information for the individual consistent with the desired change immediately after receiving the input, presenting to the individual a summary of the updated benefit program and the adjusted salary information immediately after updating the benefit program and adjusting the salary information, and allowing the individual to indicate additional changes to the benefit plan immediately after having the summary presented to the individual.

Additional features and advantages of the invention appear in the following description and will be obvious from the description, or may be learned by practicing the invention. The foregoing background and summary are not intended to be comprehensive, but instead serve to help one skilled in the art understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is a flow chart showing steps of the benefit program enrollment method consistent with the present invention;

FIG. 2 shows a computer system for implementing the method consistent with the present invention;

FIG. 3 shows another computer system for implementing the method consistent with the present invention; and

FIGS. 4A-4B show exemplary web pages created by a software application implementing the method consistent with the present invention.

### DETAILED DESCRIPTION OF THE EMBODIMENTS

The following description refers to the accompanying drawings, in which, in the absence of a contrary representation, the same numbers in different drawings represent similar elements. The following implementations do not represent all implementations consistent with the claimed invention. Instead, they are merely examples. Other implementations, and modifications of the described implementations, may also fall within the scope of present invention.

Consistent with the present invention, a benefit program enrollment method for an individual updates the salary information of the employee and presents the updated salary information to the employee during the enrollment process. The individual may be an employee, and the employer of the employee may provide the benefit program. The employee, however, does not have to wait until the end of the enrollment process to learn the amount of money left on paychecks after enrolling in the benefit program.

In the following description, the benefit program includes several plans such as health plans, dental plans, retirement fund plans, or vacation plans, and each plan may have different options. A database may be used to store the details of the plans and all information of the employees, including the salaries of the employees and the plans and options each employee has enrolled in.

A computer processor may implement he methods consistent with the present invention. For example, during enrollment, an employee interacts with the computer processor to input information, and the processor presents information to the employee.

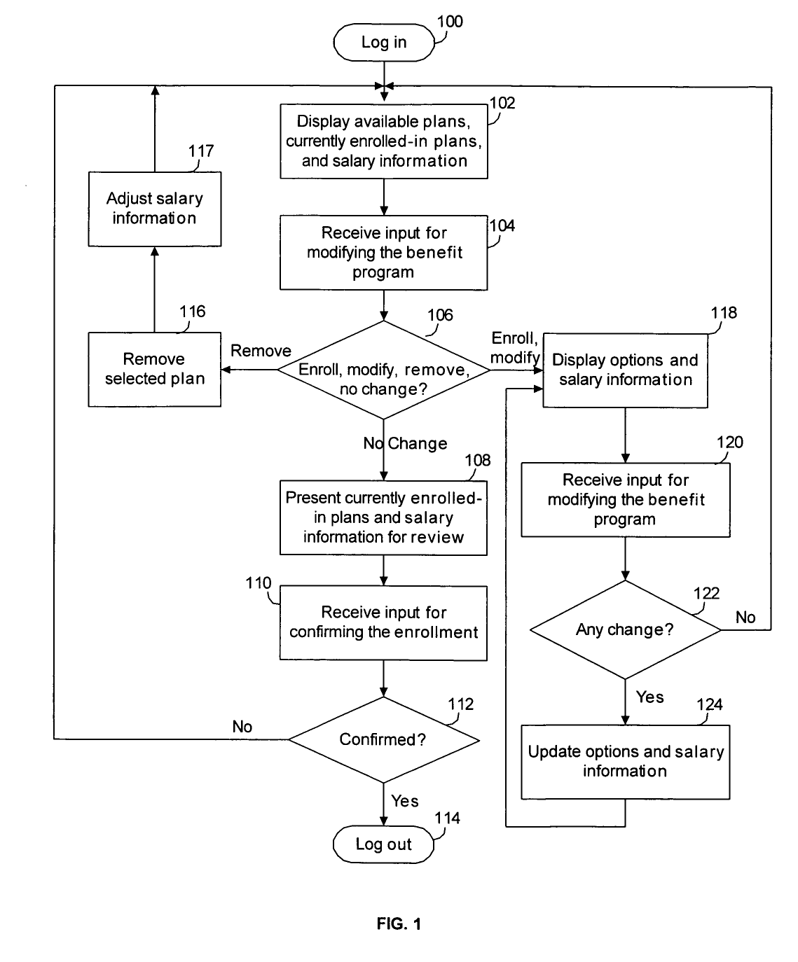

FIG. 1 is a flow chart showing steps of the benefit program enrollment method consistent with the present invention. First, an employee logs in the database. (Step 100). Then the employee is presented with a summary of the benefit program and salary information. (Step 102). The summary of the benefit program may include a list of plans available to the employee and, if the employee has already enrolled in the benefit program, the plans and options of the plans he is enrolled in.

The computer processor receives from the employee information for modifying the benefit program. (Step 104). The processor then processes the employee information. (Step 106). If the information indicates that the employee is satisfied with the benefit program, and thus chooses not to modify the benefit program, the processor presents for a final review a summary of the plans the employee has enrolled in and the relevant salary information. (Step 108). Next, the computer processor receives input from the employee for confirming the benefit program. (Step 110). If the processor receives a confirmation, it saves information about the benefit program and the salary information in the database (Step 112), and logs the employee out of the database. (Step 114).

If, on the other hand, the processor receive no confirmation (Step 112), the processor interprets this response as an indication that employee wants to make further changes to the benefit program. Therefore, the method returns to an earlier state and again presents the employee with the summary of the benefit program. (Step 102).

If the information received from the employee indicates the employee's desire to remove a plan already selected (Step 106), the processor changes the benefit program to reflect that the employee has quit the selected plan. (Step 116) Consistent with such removal, the processor adjusts the salary information of the employee (Step 117), and returns to an earlier state to present to the employee a summary of the updated benefit program and the updated salary information. (Step 102).

If the information received from the employee indicates that the employee has selected a plan to enroll in or to modify (Step 106), the processor presents to the employee options of the selected plan, together with salary information. (Step 118). If the employee had already enrolled in the plan, and selected one or more options of the plan, the employee may decide to choose or modify one or more of the options of the selected plan. (Step 120). The computer processor receives and processes the necessary information from the employee. (Step 122). If the employee modifies the choice of options of the selected plan, the processor updates the options of the selected plan and the salary information of the employee, and presents them to the employee again. (Step 118).

If the employee makes no changes to the plan and options (Step 122), the system returns the employee to the beginning of the process. Once again, the system presents the employee with a summary of the updated benefit program and updated salary information. (Step 102).

Throughout the enrollment process, when the employee is deciding which plans to enroll in (Steps 102 and 104), and which options of the plans to choose (Steps 118 and 120), the processor provides the salary information reflecting enrollment in the benefit program. The employee does not have to wait until the end of the enrollment process to see salary information, and can therefore can make a more informed decision during the enrollment process. Accordingly, the benefit program enrollment method consistent with the present invention is more convenient and more efficient than conventional methods discussed above.

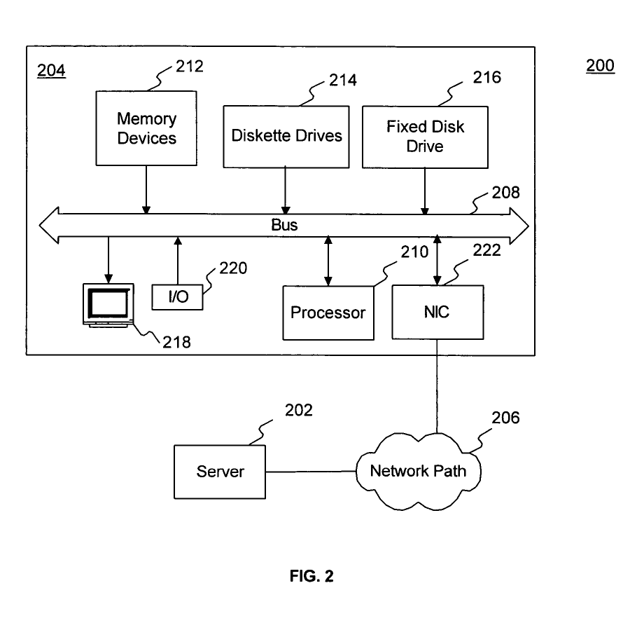

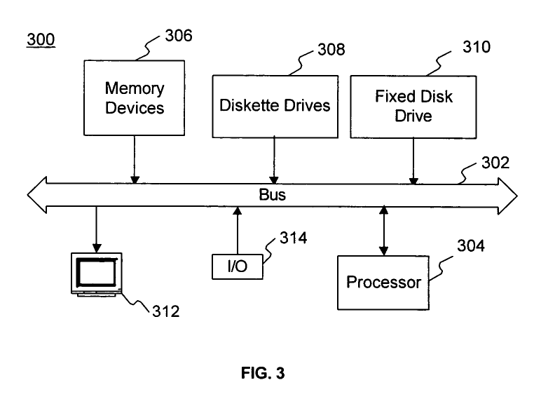

The method consistent with the present invention may be implemented as a software application stored in a computer system including a processor for executing the software application and performing the method. The computer system may be a computer network, as shown in FIG. 2, or a stand-alone personal computer (PC), as shown in FIG. 3.

In FIG. 2, a computer network 200 for implementing the benefit program enrollment method consistent with the present invention includes a server 202 and a stand-alone PC 204 connected through a network path 206. Computer network 200 may be a local area network (LAN), where server 202 and PC 204 are workstations. Computer network 200 may also be the Internet, with server 202 on the employer's side and PC 204 any workstation available to the employee. Alternatively, computer network 200 is a wide area network (WAN), and server 202 and PC 204 lie in two separate LANs connected through the Internet.

PC 204 includes a bus line 208 connecting a plurality of devices such as a processor 210, memory devices 212 for storage of information, diskette drives 214, a fixed disk drive 216, a monitor 218, other I/O devices 220, and a network interface card (NIC) 222. Processor 210 may be a microprocessor such as an Intel Pentium chip for processing applications. Memory devices 212 may include read-only memories (ROM) and/or random access memories (RAM). Diskette drives 214 may include a floppy drive and/or a compact disk (CD) drive. Fixed disk drive 216 may be a hard drive. I/O devices 220 may include a keyboard and/or a mouse for receiving input from a user of PC 204. Monitor 218 displays the output from processor 210, and may also echo the input of the user. PC 204 is connected to network path 206 through NIC 222.

The database storing the details of the benefit program and all information of the employees is stored in server 202. An employee accesses and communicates with PC 204, which further communicates with server 202 through NIC 222 and network path 206. In one aspect, the software application implementing the method consistent with the present invention is stored in PC 204 and processor 210 of PC 204 executes the software application locally within PC 204.

In another aspect, the software application implementing the method consistent with the present invention is stored in server 202, which executes the software application, and processor 210 of PC 204 communicates with server 202 to send information to server 202 and retrieve the results of the execution of the software application from server 202.

Through the execution of the software application, either locally within PC 204 or remotely within server 202, the database stored in server 202 may be accessed and modified.

Alternatively, a stand-alone PC 300 shown in FIG. 3 may be used for implementing the benefit program enrollment method consistent with the present invention. PC 300 includes a bus line 302 connecting a plurality of devices such as a processor 304, memory devices 306 for storage of information, diskette drives 308, a fixed disk drive 310, a monitor 312, and other I/O devices 314. Processor 304 may be a microprocessor such as an Intel Pentium chip for processing applications. Memory devices 306 may include ROM and/or RAM. Diskette drives 308 may include a floppy drive and/or a compact disk (CD) drive. Fixed disk drive 310 may be a hard drive. I/O devices 314 may include a keyboard and/or a mouse for receiving input from a user of PC 204. Monitor 312 displays the output of processor 304 and may also echo the input of the user.

The database storing the details of the plans and all information of the employees and the software application implementing the method consistent with the present invention may be stored together or separately on a floppy disk or a CD accessible by diskette drive 308 or on fixed disk drive 310. Processor 304 executes the software application stored in the floppy disk, the CD, or the fixed disk drive 310. An employee, through monitor 312 and I/O devices 314, interacts with processor 304, which executes the software application, thereby accessing and modifying the database.

A software application implementing the method consistent with the present invention, when executed, generates user interfaces, such as Internet web pages, to be displayed on a monitor (218 or 312). An employee may then interact with a processor (210, 202, or 304) executing the software application by viewing the Internet web pages on the monitor (218 or 312) and inputting through a keyboard or a mouse (220 or 314).

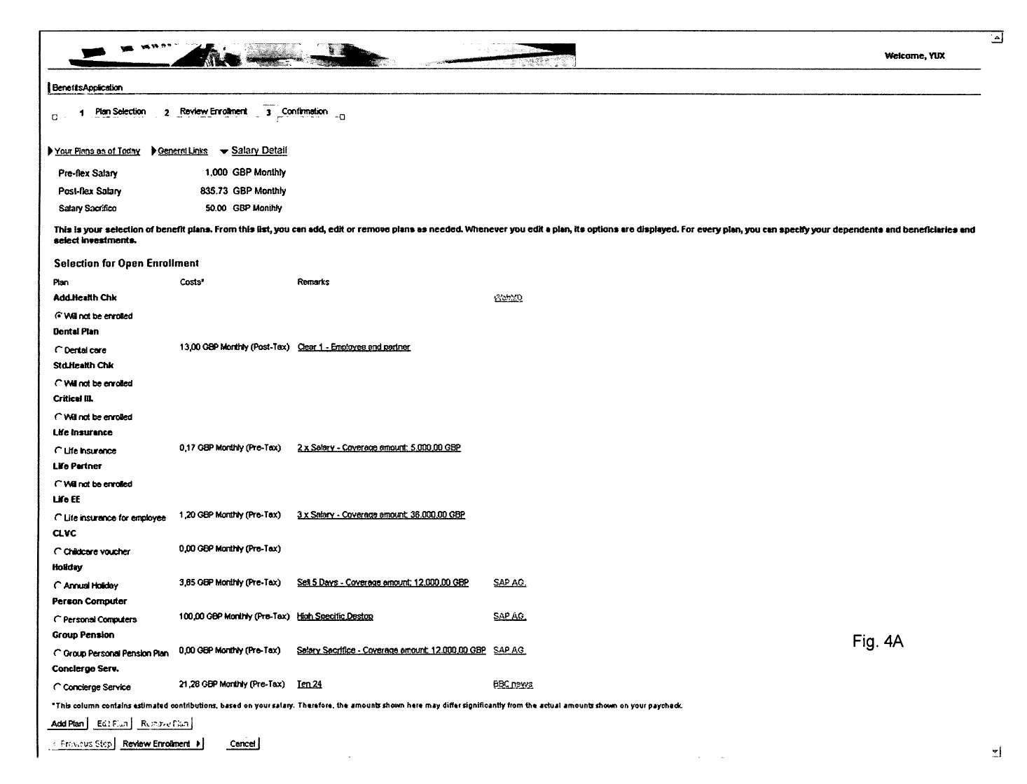

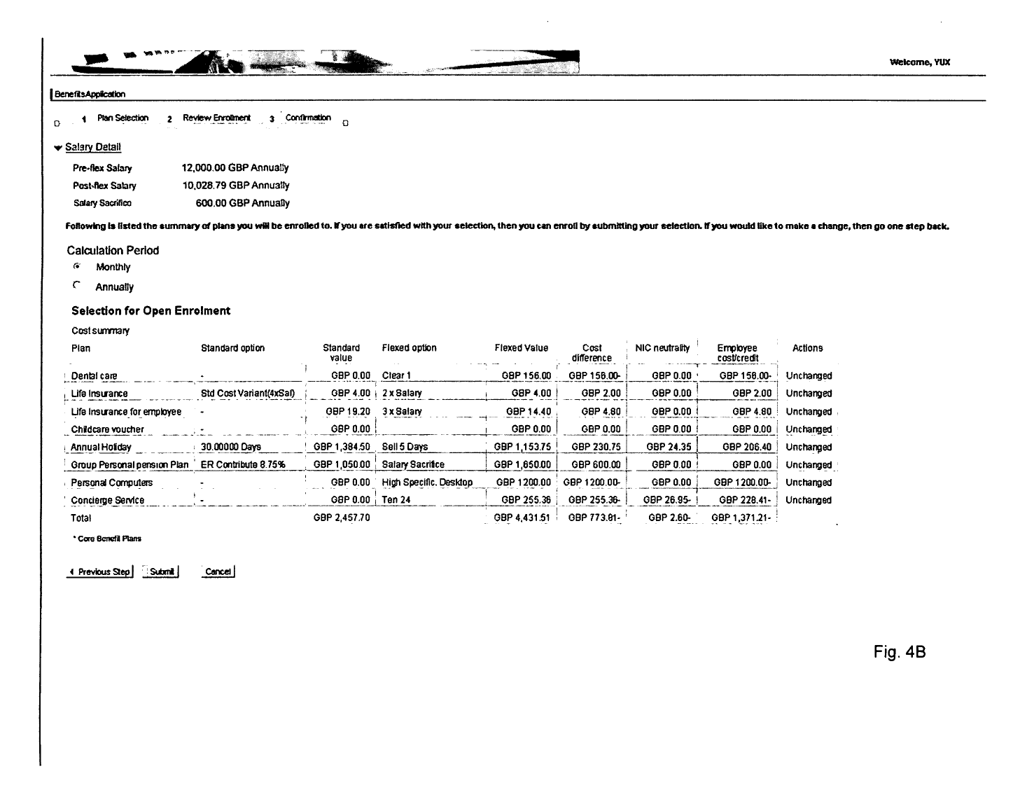

The software application implementing the method may create a web page at steps 102 and 104 such as the one shown in FIG. 4A. FIG. 4A shows a list including plans that the employee is already enrolled in, such as the dental care, the life insurance, etc., and plans that are available to the employee, such as the standard health plan (Std.Health Chk), critical illness plan (Critical III.), etc. The monthly costs of the enrolled-in plans are also shown. The employee's salary information is shown as including the gross monthly pay (pre-flex salary) prior to any deduction for the benefit program, the net monthly pay (post-flex salary) after any deduction for the benefit program, and any monthly contribution deduction (salary sacrifice) for retirement savings, such as deduction for savings for a group pension plan. Depending on the plans in which the employee is enrolled, additional salary information may be displayed. For example, in the United Kingdom, where the employer contributes a certain amount called national insurance contribution, the difference between the national insurance contribution and the cost of the benefit program, called NIC (national insurance contribution) neutrality, may be displayed. Alternatively, the summary benefit program and the salary information of the employee may each be an annual total (not shown in FIG. 4A).

As shown in FIG. 4A, the web page also includes a radio button next to each of the plans listed such that the employee may select a plan by clicking a corresponding radio button. Several function buttons at the bottom of the web page, such as “Add Plan”, “Edit Plan”, “Remove Plan”, “Review Enrollment”, etc., allow the employee to respectively choose to add the selected plan, modify the selected plan, remove the selected plan, or do nothing and proceed to review the plans he is enrolled in, etc.

For another example, if the employee has finished the enrollment, the method consistent with the present invention presents to the employee a summary of the enrolled-in plans and his updated salary information at step 108 of FIG. 1, and receives input from the employee for confirming the enrollment at step 110 of FIG. 1. Accordingly, the software application implementing the method may create a web page at steps 108 and 110 such as the one shown in FIG. 4B. In FIG. 4B, the web page shows the enrolled-in plans including dental care, life insurance, life insurance for employee, childcare voucher, annual holiday, group personal pension plan, personal computers, and concierge service. The details of the plans, such as the values and costs, and the total value and cost of the plans are also shown on the web page. Additionally, the salary information of the employee is shown on the top of the web page.

The web page of FIG. 4B also includes buttons that allow the employee to change the display of the information of the enrolled-in plans and salary information between a month basis and a year basis. For example, the employee may simply click on a radio button labeled as “Annually” to view the yearly values and costs of the plans, the gross yearly salary, the net yearly salary, the yearly salary sacrifice, etc. He may click on the radio button labeled as “Monthly” to view such information on a monthly basis. A button labeled as “Previous Step” allows the employee to go back to further modify the benefit program (step 102 of FIG. 1). A button labeled as “Submit” allows the employee to confirm the enrollment in the plans and to complete the enrollment process (step 114).

The foregoing description of possible implementations consistent with the present invention does not represent a comprehensive list of all such implementations or all variations of the implementations described. The description of only some implementations should not be construed as an intent to exclude other implementations. One skilled in the art will understand how to implement the invention in the appended claims in may other ways, using equivalents and alternatives that do not depart from the scope of the following claims. Moreover, unless indicated to the contrary in the preceding description, none of the components described in the implementations is essential to the invention.

What is claimed is:

1. A method, performed by a processing system, for updating a benefit program for an individual, the method comprising:
receiving from the individual an input indicating a desired change to the benefit program;
updating the benefit program at a data processor to reflect the desired change and to adjust salary information for the individual consistent with the desired change immediately after receiving the input;
presenting to the individual a summary of the updated benefit program and the adjusted salary information immediately after updating the benefit program and adjusting the salary information; and
allowing the individual to indicate additional changes to the benefit plan immediately after having the summary presented to the individual.

2. The method of claim 1, further including presenting to the individual, before receiving the input, a summary of the benefit program.

3. The method of claim 2, wherein presenting to the individual the summary of the benefit program includes presenting to the individual ones of the plans in which the individual is already enrolled, other ones of the plans that are available to the individual, and ones of the options of the plans the individual has selected.

4. The method of claim 2, further including presenting to the individual, before receiving the input, salary information for the individual.

5. The method of claim 4, wherein presenting to the individual the salary information includes presenting to the individual the individual's gross salary, deductions for the plans, and net salary.

6. The method of claim 1, further including allowing the individual to review a summary of ones of the plans in which the individual is enrolled and the salary information of the individual.

7. The method of claim 6, wherein allowing the individual to review the summary of the ones of the plans in which the individual is enrolled and the salary information of the individual comprises allowing the individual to review the summary and the salary information on a monthly basis or a yearly basis.

8. The method of claim 1, wherein receiving the first input comprises receiving the first input of one of a first type, a second type, and a third type, wherein the first input of the first type indicates that the individual wants to complete the enrollment, wherein both the first input of the second type and the first input of the third type include a selection of one of the plans, and wherein the first input of the second type indicates that the individual wants to remove the selected plan, and the first input of the third type indicates that the individual wants to enroll in or modify the selected plan.

9. The method of claim 8, further comprising allowing the individual to review the summary of the ones of the plans in which the individual is enrolled and the salary information is performed when the first input is of the first type.

10. The method of claim 8, wherein updating the benefit program comprises removing the selected plan from the benefit program when the first input is of the second type.

11. The method of claim 8, further comprising, when the first input is of the third type,
presenting to the individual options of the selected plan and the salary information of the individual,
receiving an additional input from the individual,
updating the options of the selected plan and the salary information of the individual consistent with the additional input, and
presenting to the individual the updated options of the selected plan and the updated salary information of the individual.

12. The method of claim 1, further comprising
receiving an additional input from the individual; and
saving the updated benefit program if the second input is a confirmation.

13. A computer-readable medium containing a program for causing a processor to perform a method for updating a benefit program for an individual, the method comprising:
receiving from the individual an input indicating a desired change to the benefit program;
updating the benefit program at a data processor to reflect the desired change and to adjust salary information for the individual consistent with the desired change immediately after receiving the input;
presenting to the individual a summary of the updated benefit program and the adjusted salary information immediately after updating the benefit program and adjusting the salary information; and
allowing the individual to indicate additional changes to the benefit plan immediately after having the summary presented to the individual.

14. The medium of claim 13, the method further including presenting to the individual, before receiving the input, a summary of the benefit program.

15. The medium of claim 14, wherein presenting to the individual the summary of the benefit program includes presenting to the individual ones of the plans in which the individual is already enrolled, other ones of the plans that are available to the individual, and ones of the options of the plans the individual has selected.

16. The medium of claim 14, the method further including presenting to the individual, before receiving the input, salary information for the individual.

17. The medium of claim 16, wherein presenting to the individual the salary information includes presenting to the individual the individual's gross salary, deductions for the plans, and net salary.

18. The medium of claim 13, the method further including allowing the individual to review a summary of ones of the plans in which the individual is enrolled and the salary information of the individual.

19. The medium of claim 18, wherein allowing the individual to review the summary of the ones of the plans in which the individual is enrolled and the salary information of the individual comprises allowing the individual to review the summary and the salary information on a monthly basis or a yearly basis.

20. The medium of claim 13, wherein receiving the first input comprises receiving the first input of one of a first type, a second type, and a third type, wherein the first input of the first type indicates that the individual wants to complete the enrollment, wherein both the first input of the second type and the first input of the third type include a selection of one of the plans, and wherein the first input of the second type indicates that the individual wants to remove the selected plan, and the first input of the third type indicates that the individual wants to enroll in or modify the selected plan.

21. The medium of claim 20, the method further comprising allowing the individual to review the summary of the ones of the plans in which the individual is enrolled and the salary information is performed when the first input is of the first type.

22. The medium of claim 20, wherein updating the benefit program comprises removing the selected plan from the benefit program when the first input is of the second type.

23. The medium of claim 20, the method further comprising, when the first input is of the third type,
presenting to the individual options of the selected plan and the salary information of the individual,
receiving an additional input from the individual,
updating the options of the selected plan and the salary information of the individual consistent with the additional input, and
presenting to the individual the updated options of the selected plan and the updated salary information of the individual.

24. The medium of claim 13, the method further comprising
receiving an additional input from the individual; and
saving the updated benefit program if the second input is a confirmation.

25. A computer system, comprising:
a processor; and
means for accessing a computer-readable medium containing a program for causing the processor to perform a method for updating a benefit program for an individual, the benefit program including a plurality of plans, the plans including a plurality of options, and the method comprising
receiving from the individual an input indicating a desired change to the benefit program,
updating the benefit program at a data processor to reflect the desired change and to adjust salary information for the individual consistent with the desired change immediately after receiving the input,
presenting to the individual a summary of the updated benefit program and the adjusted salary information immediately after updating the benefit program and adjusting the salary information, and
allowing the individual to indicate additional changes to the benefit plan immediately after having the summary presented to the individual.

26. The system of claim 25, the method further including presenting to the individual, before receiving the input, a summary of the benefit program.

27. The system of claim 26, wherein presenting to the individual the summary of the benefit program includes presenting to the individual ones of the plans in which the individual is already enrolled, other ones of the plans that are available to the individual, and ones of the options of the plans the individual has selected.

28. The system of claim 26, the method further including presenting to the individual, before receiving the input, salary information for the individual.

29. The system of claim 28, wherein presenting to the individual the salary information includes presenting to the individual the individual's gross salary, deductions for the plans, and net salary.

30. The system of claim 25, the method further including allowing the individual to review a summary of ones of the plans in which the individual is enrolled and the salary information of the individual.

31. The system of claim 30, wherein allowing the individual to review the summary of the ones of the plans in which the individual is enrolled and the salary information of the individual comprises allowing the individual to review the summary and the salary information on a monthly basis or a yearly basis.

32. The system of claim 25, wherein receiving the first input comprises receiving the first input of one of a first type, a second type, and a third type, wherein the first input of the first type indicates that the individual wants to complete the enrollment, wherein both the first input of the second type and the first input of the third type include a selection of one of the plans, and wherein the first input of the second type indicates that the individual wants to remove the selected plan, and the first input of the third type indicates that the individual wants to enroll in or modify the selected plan.

33. The system of claim 32, the method further comprising allowing the individual to review the summary of the ones of the plans in which the individual is enrolled and the salary information is performed when the first input is of the first type.

34. The system of claim 32, wherein updating the benefit program comprises removing the selected plan from the benefit program when the first input is of the second type.

35. The system of claim 32, the method further comprising, when the first input is of the third type,
presenting to the individual options of the selected plan and the salary information of the individual,
receiving an additional input from the individual,
updating the options of the selected plan and the salary information of the individual consistent with the additional input, and
presenting to the individual the updated options of the selected plan and the updated salary information of the individual.

36. The system of claim 25, the method further comprising
receiving an additional input from the individual; and
saving the updated benefit program if the second input is a confirmation.

37. The system of claim 25, wherein the computer-readable medium is a hard disk.

38. The system of claim 25, wherein the computer-readable medium is a floppy disk or a compact disk (CD), and the means comprises a floppy drive or a CD drive.
